(19) United States
(12) Patent Application Publication
(10) Pub. No.: US 2007/0070309 A1
(43) Pub. Date: Mar. 29, 2007

(54) Color image projection arrangement and method employing electro-absorption modulated green laser system

(76) Inventor: Miklos Stern, Woodmere, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/237,389

(22) Filed: Sep. 28, 2005

(51) Int. Cl. G03B 21/22

(52) U.S. Cl. 353/119

(57) ABSTRACT

A lightweight, compact image projection module is operative for causing selected pixels in a raster pattern to be illuminated to produce an image of high resolution of VGA quality in color. An electro-absorption modulated green laser system is employed for energy efficiency and to reduce size and weight of the module.

### BACKGROUND OF THE INVENTION

1. Field of the Invention

The present invention generally relates to projecting a two-dimensional image in color by employing an electro-absorption green laser system during such image projection in order to achieve low power consumption, high resolution and miniature compact size and weight.

2. Description of the Related Art

It is generally known to project a two-dimensional color image on a screen based on a pair of scan mirrors which oscillate in mutually orthogonal directions to scan a laser beam derived from red, blue and green laser systems over a raster pattern. The red and blue laser systems include solid-state, semiconductor lasers which are readily directly modulated and pulsed at frequencies on the order of 100 MHz. However, the currently available green solid-state lasers cannot be pulsed at such high frequencies. As a result, the green laser system includes an infrared diode-pumped YAG crystal laser whose output beam has a wavelength on the order of 1060 nm, and a non-linear frequency doubling crystal, preferably included in the laser cavity, to cause a green laser beam having a wavelength on the order of 530 nm to be emitted. An external, acousto-optical modulator is employed to pulse the emitted green beam.

Although generally satisfactory for its intended purpose, the known frequency-doubled, diode-pumped, solid-state, externally-modulated, green laser system accounts for approximately half the size, weight, cost and electrical power consumption of the arrangement for projecting the color image, thereby rendering such known image projection arrangements impractical for use in miniature, hand-held, battery-operated applications where physical size, weight, cost and power consumption must be kept to a minimum.

### SUMMARY OF THE INVENTION

### OBJECTS OF THE INVENTION

Accordingly, it is a general object of this invention to minimize power consumption, physical size, weight and cost of a color image projection arrangement.

Another object of this invention is to provide an alternative green laser system for use in the color image projection arrangement.

An additional object is to provide a miniature, compact, lightweight, energy-efficient, and portable color image projection arrangement useful in many instruments of different form factors, especially handheld instruments.

### FEATURES OF THE INVENTION

In keeping with these objects and others which will become apparent hereinafter, one feature of this invention resides, briefly stated, in an image projection arrangement for projecting a two-dimensional, color image. The arrangement includes a support; a plurality of red, blue and green lasers for respectively emitting red, blue and green laser beams; a scanner for sweeping a pattern of scan lines in space at a working distance from the support, each scan line having a number of pixels; and a controller for causing selected pixels to be illuminated, and rendered visible, by the laser beams to produce the color image.

In the preferred embodiment, an optical assembly is provided on the support between the lasers and the scanner, for optically focusing and collinearly arranging the laser beams to form a composite beam directed to the scanner. The scanner includes a pair of oscillatable scan mirrors for sweeping the composite beam along generally mutually orthogonal directions at different scan rates and at different scan angles. At least one of the scan rates exceeds audible frequencies, for example, over 18 kHz, to reduce noise. At least one of the scan mirrors is driven by an inertial drive to minimize power consumption. The image resolution preferably exceeds one-fourth of VGA quality, but typically equals or exceeds VGA quality. The support, lasers, scanner, controller and optical assembly preferably occupy a volume of less than thirty cubic centimeters.

The arrangement is interchangeably mountable in housings of different form factors, including, but not limited to, a pen-shaped, gun-shaped or flashlight-shaped instrument, a personal digital assistant, a pendant, a watch, a computer, and, in short, any shape due to its compact and miniature size. The projected image can be used for advertising or signage purposes, or for a television or computer monitor screen, and, in short, for any purpose desiring something to be displayed.

In accordance with this invention, the green laser includes an edge-emitting infrared laser diode for emitting an infrared beam having a wavelength on the order of 1060 nm, an electro-absorption modulator for modulating the infrared beam, and a second harmonic generator for converting the modulated, infrared beam to a green laser beam having a wavelength on the order of 530 nm. The infrared diode is preferably a distributed feedback laser diode which is fabricated on a common semiconductor chip with the modulator. The infrared diode could also be a three section, distributed Bragg reflector. The second harmonic generator is preferably a periodically poled waveguide.

This green laser is energy efficient and consumes much less power than other green laser systems. This green laser is likewise lighter in weight and smaller in size than other green laser systems. This green laser allows the image projector to be more compact and to be used in many more applications, especially in hand-held instruments.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a hand-held instrument projecting an image at a working distance therefrom;

FIG. 2 is an enlarged, overhead, perspective view of an image projection arrangement for installation in the instrument of FIG. 1;

FIG. 3 is a top plan view of the arrangement of FIG. 2;

FIG. 4 is a perspective front view of an inertial drive for use in the arrangement of FIG. 2;

FIG. 5 is a perspective rear view of the inertial drive of FIG. 4;

FIG. 6 is a perspective view of a practical implementation of the arrangement of FIG. 2;

FIG. 7 is an electrical schematic block diagram depicting operation of the arrangement of FIG. 2;

FIG. 8 is a perspective view of a detail of an alternative green laser system in accordance with this invention; and

FIG. 9 is a block diagram of the alternative green laser system for use in the arrangement of FIG. 2.

### DETAILED DESCRIPTION OF THE PREFERRED EMBODIMENTS

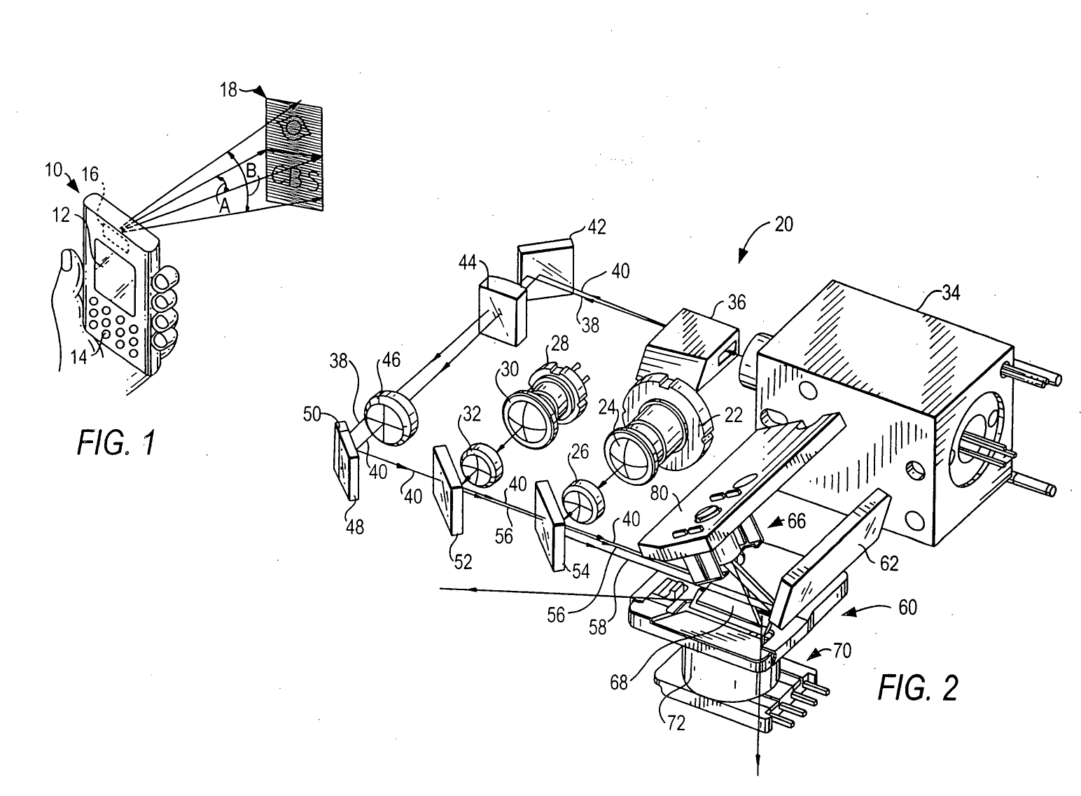

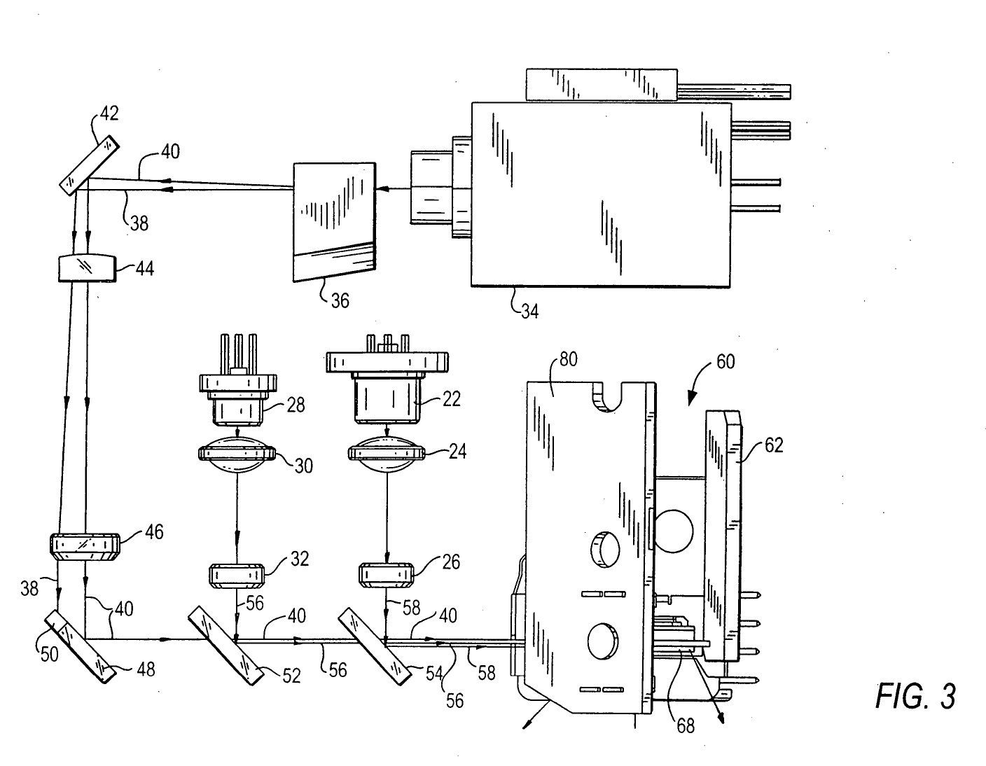

Reference numeral 10 in FIG. 1 generally identifies a hand-held instrument, for example, a personal digital assistant, in which a lightweight, compact, image projection arrangement 20, as shown in FIG. 2, is mounted and operative for projecting a two-dimensional color image at a variable distance from the instrument. By way of example, an image 18 is situated within a working range of distances relative to the instrument 10.

As shown in FIG. 1, the image 18 extends over an optical horizontal scan angle A extending along the horizontal direction, and over an optical vertical scan angle B extending along the vertical direction, of the image. As described below, the image is comprised of illuminated and non-illuminated pixels on a raster pattern of scan lines swept by a scanner in the arrangement 20.

The parallelepiped shape of the instrument 10 represents just one form factor of a housing in which the arrangement 20 may be implemented. The instrument can be shaped as a pen, a cellular telephone, a clamshell or a wristwatch, as, for example, shown in U.S. Pat. No. 6,832,724, assigned to the same assignee as the instant application, and incorporated herein by reference thereto.

In the preferred embodiment, the arrangement 20 measures less than about 30 cubic centimeters in volume. This compact, miniature size allows the arrangement 20 to be mounted in housings of many diverse shapes, large or small, portable or stationary, including some having an on-board display 12, a keypad 14, and a window 16 through which the image is projected.

Referring to FIGS. 2 and 3, the arrangement 20 includes a solid-state, preferably a semiconductor laser 22 which, when energized, emits a bright red laser beam at about 635-655 nanometers. Lens 24 is a biaspheric convex lens having a positive focal length and is operative for collecting virtually all the energy in the red beam and for producing a diffraction-limited beam. Lens 26 is a concave lens having a negative focal length. Lenses 24,26 are held by respective lens holders apart on a support (not illustrated in FIG. 2 for clarity) inside the instrument 10. The lenses 24, 26 shape the red beam profile over the working distance.

Another solid-state, semiconductor laser 28 is mounted on the support and, when energized, emits a diffraction-limited blue laser beam at about 475-505 nanometers. Another biaspheric convex lens 30 and a concave lens 32 are employed to shape the blue beam profile in a manner analogous to lenses 24, 26.

A green laser beam having a wavelength on the order of 530 nanometers is generated not by a semiconductor laser, but instead by a green module 34 having an infrared diode-pumped YAG crystal laser whose output beam at 1060 nanometers. A non-linear frequency doubling crystal is included in the infrared laser cavity between the two laser mirrors. Since the infrared laser power inside the cavity is much larger than the power coupled outside the cavity, the frequency doubler is more efficient in generating the double frequency green light inside the cavity. The output mirror of the laser is reflective to the 1060 nm infrared radiation, and transmissive to the doubled 530 nm green laser beam. Since the correct operation of the solid-state laser and frequency doubler require precise temperature control, a semiconductor device relying on the Peltier effect is used to control the temperature of the green laser module. A thermo-electric cooler can either heat or cool the device depending on the polarity of the applied current. A thermistor is part of the green laser module in order to monitor its temperature. The readout from the thermistor is fed to the controller, which adjusts the control current to the thermo-electric cooler accordingly.

As explained below, the lasers are pulsed in operation at frequencies on the order of 100 MHz. The red and blue semiconductor lasers 22, 28 can be directly pulsed at such high frequencies, but the currently available green solid-state lasers cannot. As a result, the green laser beam exiting the green module 34 is pulsed with an acousto-optical modulator 36 which creates an acoustic standing wave inside a crystal for diffracting the green beam. The modulator 36, however, produces a zero-order, non-diffracted beam 38 and a first-order, pulsed, diffracted beam 40. The beams 38, 40 diverge from each other and, in order to separate them to eliminate the undesirable zero-order beam 38, the beams 38, 40 are routed along a long, folded path having a folding mirror 42. Alternatively, the electro-optical modulator can be used internally to the green laser module to pulse the green laser beam. Other possible ways to modulate the green laser beam include electro-absorption modulation as described below, or a Mach-Zender interferometer.

The beams 38, 40 are routed through positive and negative lenses 44, 46. However, only the diffracted green beam 40 is allowed to impinge upon, and reflect from, the folding mirror 48. The non-diffracted beam 38 is absorbed by an absorber 50, preferably mounted on the mirror 48.

The arrangement includes a pair of dichroic filters 52, 54 arranged to make the green, blue and red beams as collinear as possible before reaching a scanning assembly 60. Filter 52 allows the green beam 40 to pass therethrough, but the blue beam 56 from the blue laser 28 is reflected by the interference effect. Filter 54 allows the green and blue beams 40, 56 to pass therethrough, but the red beam 58 from the red laser 22 is reflected by the interference effect.

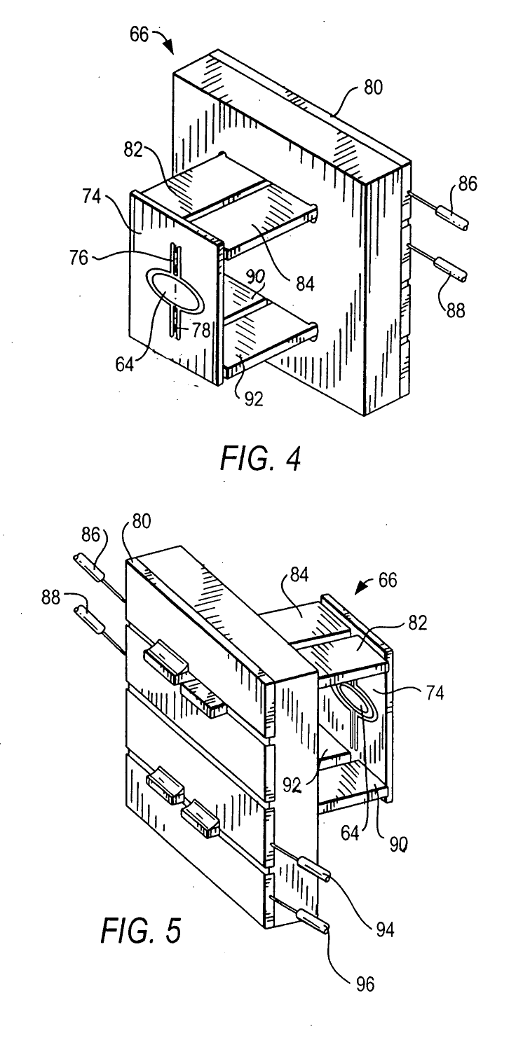

The nearly collinear beams 40, 56, 58 are directed to, and reflected off a stationary bounce mirror 62. The scanning assembly 60 includes a first scan mirror 64 oscillatable by an inertial drive 66 (shown in isolation in FIGS. 4-5) at a first scan rate to sweep the laser beams reflected off the bounce mirror 62 over the first horizontal scan angle A, and a second scan mirror 68 oscillatable by an electromagnetic drive 70 at a second scan rate to sweep the laser beams reflected off the first scan mirror 64 over the second vertical scan angle B. In a variant construction, the scan mirrors 64, 68 can be replaced by a single two-axis mirror.

The inertial drive 66 is a high-speed, low electrical power-consuming component. Details of the inertial drive can be found in U.S. patent application Ser. No. 10/387,878, filed Mar. 13, 2003, assigned to the same assignee as the instant application, and incorporated herein by reference thereto. The use of the inertial drive reduces power consumption of the scanning assembly 60 to less than one watt and, in the case of projecting a color image, as described below, to less than ten watts.

The drive 66 includes a movable frame 74 for supporting the scan mirror 64 by means of a hinge that includes a pair of collinear hinge portions 76, 78 extending along a hinge axis and connected between opposite regions of the scan mirror 64 and opposite regions of the frame. The frame 74 need not surround the scan mirror 64, as shown.

The frame, hinge portions and scan mirror are fabricated of a one-piece, generally planar, silicon substrate which is approximately 150μ thick. The silicon is etched to form omega-shaped slots having upper parallel slot sections, lower parallel slot sections, and U-shaped central slot sections. The scan mirror 64 preferably has an oval shape and is free to move in the slot sections. In the preferred embodiment, the dimensions along the axes of the oval-shaped scan mirror measure 749μ×1600μ. Each hinge portion measure 27μ in width and 1130μ in length. The frame has a rectangular shape measuring 3100μ in width and 4600μ in length.

The inertial drive is mounted on a generally planar, printed circuit board 80 and is operative for directly moving the frame and, by inertia, for indirectly oscillating the scan mirror 64 about the hinge axis. One embodiment of the inertial drive includes a pair of piezoelectric transducers 82, 84 extending perpendicularly of the board 80 and into contact with spaced apart portions of the frame 74 at either side of hinge portion 76. An adhesive may be used to insure a permanent contact between one end of each transducer and each frame portion. The opposite end of each transducer projects out of the rear of the board 80 and is electrically connected by wires 86, 88 to a periodic alternating voltage source (not shown).

In use, the periodic signal applies a periodic drive voltage to each transducer and causes the respective transducer to alternatingly extend and contract in length. When transducer 82 extends, transducer 84 contracts, and vice versa, thereby simultaneously pushing and pulling the spaced apart frame portions and causing the frame to twist about the hinge axis. The drive voltage has a frequency corresponding to the resonant frequency of the scan mirror. The scan mirror is moved from its initial rest position until it also oscillates about the hinge axis at the resonant frequency. In a preferred embodiment, the frame and the scan mirror are about 150μ thick, and the scan mirror has a high Q factor. A movement on the order of 1μ by each transducer can cause oscillation of the scan mirror at scan rates in excess of 20 kHz.

Another pair of piezoelectric transducers 90, 92 extends perpendicularly of the board 80 and into permanent contact with spaced apart portions of the frame 74 at either side of hinge portion 78. Transducers 90, 92 serve as feedback devices to monitor the oscillating movement of the frame and to generate and conduct electrical feedback signals along wires 94, 96 to a feedback control circuit (not shown).

Alternatively, instead of using piezo-electric transducers 90,92 for feedback, magnetic feedback can be used, where a magnet is mounted on the back of the high-speed mirror, and external coil is used to pickup the changing magnetic field generated by the oscillating magnet.

Although light can reflect off an outer surface of the scan mirror, it is desirable to coat the surface of the mirror 64 with a specular coating made of gold, silver, aluminum, or a specially designed highly reflective dielectric coating.

The electromagnetic drive 70 includes a permanent magnet jointly mounted on and behind the second scan mirror 68, and an electromagnetic coil 72 operative for generating a periodic magnetic field in response to receiving a periodic drive signal. The coil 72 is adjacent the magnet so that the periodic field magnetically interacts with the permanent field of the magnet and causes the magnet and, in turn, the second scan mirror 68 to oscillate.

The inertial drive 66 oscillates the scan mirror 64 at a high speed at a scan rate preferably greater than 5 kHz and, more particularly, on the order of 18 kHz or more. This high scan rate is at an inaudible frequency, thereby minimizing noise and vibration. The electromagnetic drive 70 oscillates the scan mirror 68 at a slower scan rate on the order of 40 Hz which is fast enough to allow the image to persist on a human eye retina without excessive flicker.

The faster mirror 64 sweeps a horizontal scan line, and the slower mirror 68 sweeps the horizontal scan line vertically, thereby creating a raster pattern which is a grid or sequence of roughly parallel scan lines from which the image is constructed. Each scan line has a number of pixels. The image resolution is preferably XGA quality of 1024×768 pixels. Over a limited working range, a high-definition television standard, denoted 720 p, 1270×720 pixels, can be displayed. In some applications, a one-half VGA quality of 320×480 pixels, or one-fourth VGA quality of 320×240 pixels, is sufficient. At minimum, a resolution of 160 x 160 pixels is desired.

The roles of the mirrors 64, 68 could be reversed so that mirror 68 is the faster, and mirror 64 is the slower. Mirror 64 can also be designed to sweep the vertical scan line, in which event, mirror 68 would sweep the horizontal scan line. Also, the inertial drive can be used to drive the mirror 68. Indeed, either mirror can be driven by an electromechanical, electrical, mechanical, electrostatic, magnetic, or electromagnetic drive.

The slower mirror is operated in a constant velocity sweep-mode during which time the image is displayed. During the mirror's return, the mirror is swept back into the initial position at its natural frequency, which is significantly higher. During the mirror's return trip, the lasers can be powered down in order to reduce the power consumption of the device.

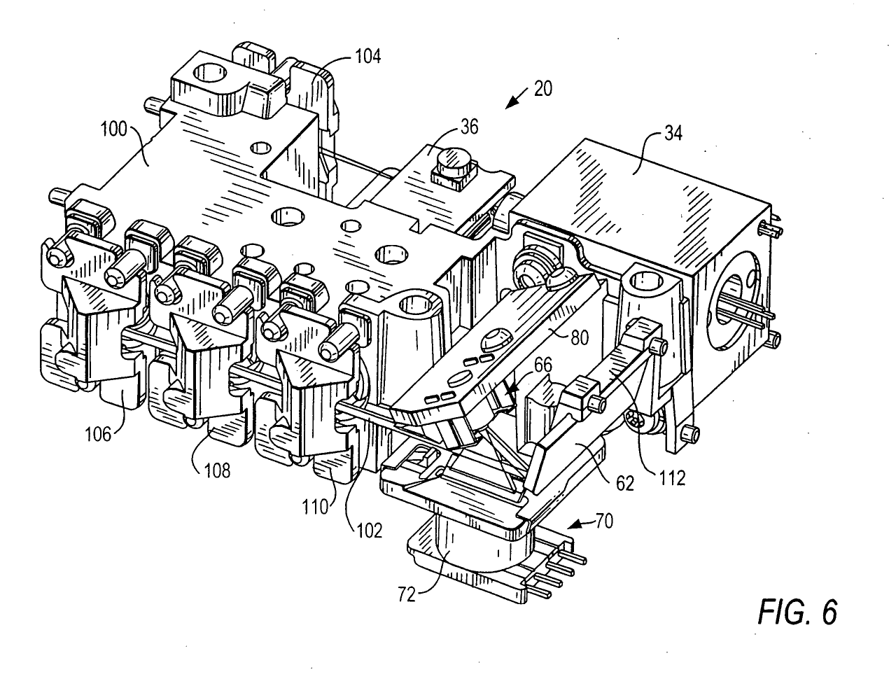

FIG. 6 is a practical implementation of the arrangement 20 in the same perspective as that of FIG. 2. The aforementioned components are mounted on a support which includes a top cover 100 and a support plate 102. Holders 104, 106, 108, 110, 112 respectively hold folding mirrors 42, 48, filters 52, 54 and bounce mirror 62 in mutual alignment. Each holder has a plurality of positioning slots for receiving positioning posts stationarily mounted on the support. Thus, the mirrors and filters are correctly positioned. As shown, there are three posts, thereby permitting two angular adjustments and one lateral adjustment. Each holder can be glued in its final position.

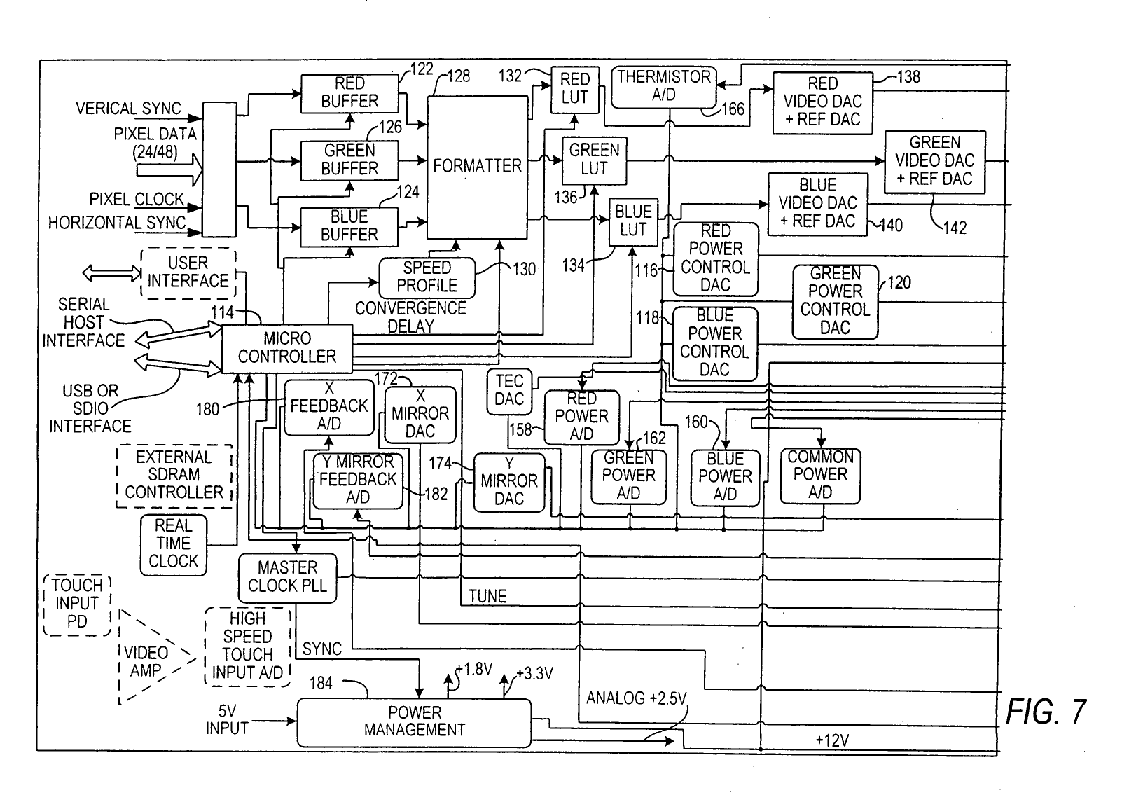

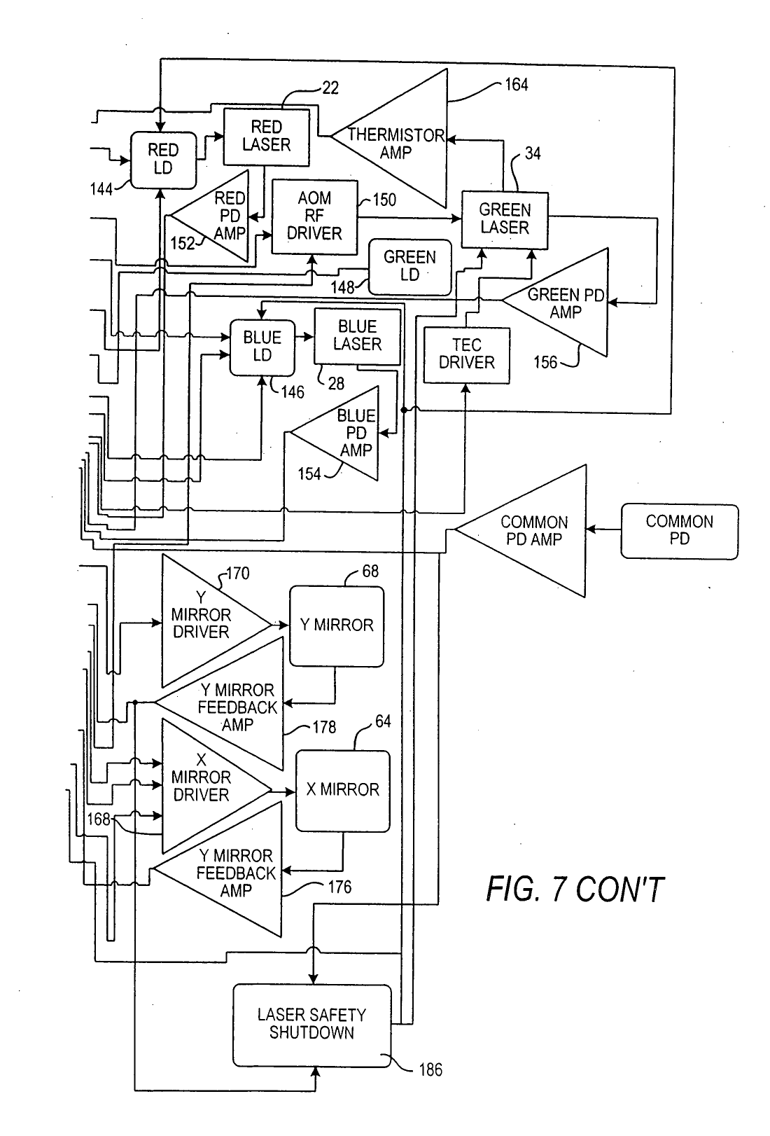

The image is constructed by selective illumination of the pixels in one or more of the scan lines. As described below in greater detail with reference to FIG. 7, a controller 114 causes selected pixels in the raster pattern to be illuminated, and rendered visible, by the three laser beams. For example, red, blue and green power controllers 116, 118, 120 respectively conduct electrical currents to the red, blue and green lasers 22, 28, 34 to energize the latter to emit respective light beams at each selected pixel, and do not conduct electrical currents to the red, blue and green lasers to deenergize the latter to non-illuminate the other non-selected pixels. The resulting pattern of illuminated and non-illuminated pixels comprise the image, which can be any display of human- or machine-readable information or graphic.

Referring to FIG. 1, the raster pattern is shown in an enlarged view. Starting at an end point, the laser beams are swept by the inertial drive along the horizontal direction at the horizontal scan rate to an opposite end point to form a scan line. Thereupon, the laser beams are swept by the electromagnetic drive 70 along the vertical direction at the vertical scan rate to another end point to form a second scan line. The formation of successive scan lines proceeds in the same manner.

The image is created in the raster pattern by modulating or pulsing the lasers on and off at selected times under control of the microprocessor 114 or control circuit by operation of the power controllers 116, 118, 120. The lasers produce visible light and are turned on only when a pixel in the desired image is desired to be seen. The color of each pixel is determined by one or more of the colors of the beams. Any color in the visible light spectrum can be formed by the selective superimposition of one or more of the red, blue, and green lasers. The raster pattern is a grid made of multiple pixels on each line, and of multiple lines. The image is a bit-map of selected pixels. Every letter or number, any graphical design or logo, and even machine-readable bar code symbols, can be formed as a bit-mapped image.

As shown in FIG. 7, an incoming video signal having vertical and horizontal synchronization data, as well as pixel and clock data, is sent to red, blue and green buffers 122, 124, 126 under control of the microprocessor 114. The storage of one full VGA frame requires many kilobytes, and it would be desirable to have enough memory in the buffers for two full frames to enable one frame to be written, while another frame is being processed and projected. The buffered data is sent to a formatter 128 under control of a speed profiler 130 and to red, blue and green look up tables (LUTs) 132, 134, 136 to correct inherent internal distortions caused by scanning, as well as geometrical distortions caused by the angle of the display of the projected image. The resulting red, blue and green digital signals are converted to red, blue and green analog signals by digital to analog converters (DACs) 138, 140, 142. The red and blue analog signals are fed to red and blue laser drivers (LDs) 144, 146 which are also connected to the red and blue power controllers 116, 118. The green analog signal is fed to an acousto-optical module (AOM) radio frequency (RF) driver 150 and, in turn, to the green laser 34 which is also connected to a green LD 148 and to the green power controller 120.

Feedback controls are also shown in FIG. 7, including red, blue and green photodiode amplifiers 152, 154, 156 connected to red, blue and green analog-to-digital (A/D) converters 158, 160, 162 and, in turn, to the microprocessor 114. Heat is monitored by a thermistor amplifier 164 connected to an A/D converter 166 and, in turn, to the microprocessor.

The scan mirrors 64, 68 are driven by drivers 168, 170 which are fed analog drive signals from DACs 172, 174 which are, in turn, connected to the microprocessor. Feedback amplifiers 176, 178 detect the position of the scan mirrors 64, 68, and are connected to feedback A/Ds 180, 182 and, in turn, to the microprocessor.

A power management circuit 184 is operative to minimize power while allowing fast on-times, preferably by keeping the green laser on all the time, and by keeping the current of the red and blue lasers just below the lasing threshold.

A laser safety shut down circuit 186 is operative to shut the lasers off if either of the scan mirrors 64, 68 is detected as being out of position.

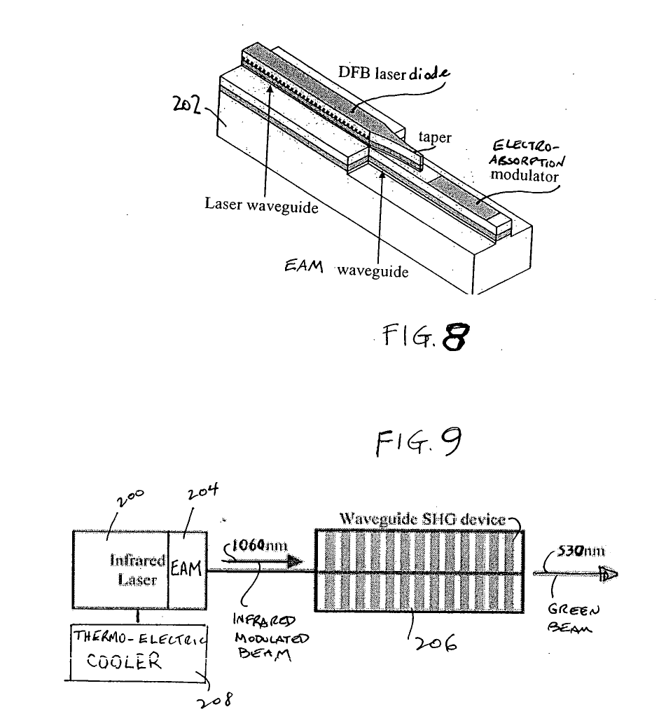

As previously described, the green module 34 having an infrared diode-pumped YAG crystal laser and a non-linear frequency doubling crystal, as well as the acousto-optical modulator 36, account for approximately half the size, weight, cost and electrical power consumption of the image projection arrangement 20. FIG. 9 schematically depicts an alternative green laser system that reduces the size, weight, cost and power consumption and renders the arrangement 20 more suitable for hand-held applications, such as the instrument 10. FIG. 8 depicts a detail of the system of FIG. 9.

The alternative green laser system includes an infrared laser 200 for emitting an infrared beam having a wavelength of about 1060 nm. The laser 200 is preferably a wavelength stabilized, edge-emitting laser diode which, as shown in FIG. 8, is a distributed feedback (DFB) laser fabricated with a laser waveguide on a semiconductor chip or substrate 202. The laser 200 could also be a distributed Bragg reflector (DBR) laser.

An electro-absorption modulator (EAM) 204 is a semiconductor device which allows the intensity of the infrared beam emitted by the laser diode 200 to be controlled via an electrical voltage based on the Franz-Keldysh effect. The EAM 204 includes a modulator waveguide with electrodes for applying an electric field in a direction perpendicular to the modulated infrared beam in order to control the optical transmission thereof. Compared to the AOM 36, the EAM 204 operates with much lower voltages, requires much less power, and operates at very high modulation speeds. A modulation bandwidth of tens of gigahertz can be achieved.

Conveniently, the EAM 204 is integrated with the DFB laser diode on the same chip 202. Although the EAM can be a separate chip, such integration allows better matching of the laser wavelength to the EAM bandgap and eliminates the need for alignment between separate chips. A taper, as depicted in FIG. 8, couples the infrared beam emitted by the laser diode to the underlying EAM waveguide.

The modulated beam output by the EAM 204 is coupled into a second harmonic generating (SHG) crystal which can either be a bulk device (such as KTP) or a waveguide 206, as depicted in FIG. 9. A waveguide is preferred for its higher conversion efficiency, and preferably a long periodically poled lithium niobate (PPLN) waveguide is used to convert the incoming modulated infrared beam having a wavelength of about 1060 nm to an outgoing modulated green beam having a wavelength of about 530 nm.

In order to maintain stability of the wavelength of the infrared beam, a thermo-electric cooler 208 is employed to maintain the laser 200 at a constant temperature. There may be a requirement to stabilize the temperature of the SHG waveguide 206 as well.

Since the conversion from infrared to green light is proportional to the intensity square of the output power of the infrared laser beam, the modulation performed by the EAM should be calibrated if a linear variation of the green laser output is desired.

It will be understood that each of the elements described above, or two or more together, also may find a useful application in other types of constructions differing from the types described above.

While the invention has been illustrated and described as embodied in a color image projection arrangement and method employing an electro-absorption modulated green laser system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. An image projection arrangement for projecting a two-dimensional, color image, comprising:
a) a support;
b) a laser assembly on the support, for emitting a composite beam comprised of a plurality of laser beams of different wavelengths;
c) a scanner on the support, for sweeping the composite beam as a pattern of scan lines in space at a working distance from the support, each scan line having a number of pixels;
d) a controller operatively connected to the laser assembly and the scanner, for causing selected pixels to be illuminated, and rendered visible, by the laser beams to produce the image; and
e) the laser assembly including an edge-emitting laser diode for emitting an infrared beam having a wavelength, an electro-absorption modulator for modulating the infrared beam, and a second harmonic generator for halving the wavelength of the infrared, modulated beam to generate a green laser beam as one of said plurality of laser beams.

2. The image projection arrangement of claim 1, wherein the laser assembly includes red and blue, solid-state, semiconductor lasers for respectively generating red and blue laser beams.

3. The image projection arrangement of claim 1, wherein the scanner includes a first oscillatable scan mirror for sweeping the composite beam along a first direction at a first scan rate and over a first scan angle, and a second oscillatable scan mirror for sweeping the composite beam along a second direction substantially perpendicular to the first direction, and at a second scan rate different from the first scan rate, and at a second scan angle different from the first scan angle.

4. The image projection arrangement of claim 1, wherein the controller includes means for energizing the laser assembly to illuminate the selected pixels, and for deenergizing the laser assembly to non-illuminate pixels other than the selected pixels.

5. The image projection arrangement of claim 1, and an optical assembly on the support between the laser assembly and the scanner, for focusing and collinearly arranging the laser beams to form the composite beam.

6. The image projection arrangement of claim 1, wherein the edge-emitting laser diode is a distributed feedback diode for emitting the infrared beam with a wavelength on the order of 1060 nanometers.

7. The image projection arrangement of claim 1, wherein the edge-emitting laser diode and the electro-absorption modulator are integrated on a common semiconductor chip.

8. The image projection arrangement of claim 1, wherein the second harmonic generator includes a poled waveguide for converting the wavelength of the infrared beam to the wavelength of the green laser beam.

9. The image projection arrangement of claim 1, and a thermo-electric cooler for controlling a temperature of the edge-emitting laser diode.

10. A method of projecting a two-dimensional, color image at a variable distance, comprising the steps of:
a) emitting a composite beam comprised of a plurality of laser beams of different wavelengths;
b) sweeping the composite beam as a pattern of scan lines in space, each scan line having a number of pixels;
c) causing selected pixels to be illuminated, and rendered visible, by the laser beams to produce the image; and
d) the emitting step being performed by electro-absorption modulating an infrared beam having a wavelength, and by halving the wavelength of the infrared beam to generate a green laser beam as one of said plurality of laser beams.

11. The method of claim 10, wherein the infrared beam is emitted by an edge-emitting infrared laser diode, wherein the modulating step is performed by an electro-absorption modulator, and the step of fabricating the infrared diode and the modulator on a common semiconductor chip.

12. The method of claim 10, wherein the halving step is performed by converting the wavelength of the infrared beam to the wavelength of the green laser beam by passing the modulated, infrared beam through a poled waveguide.

13. The method of claim 11, and controlling a temperature of the infrared diode.

14. An electro-absorption modulated green laser system, comprising:
a) an edge-emitting laser diode for emitting an infrared beam having a wavelength on the order of 1060 nanometers;
b) an electro-absorption modulator for modulating the infrared beam to form a modulated, infrared beam; and
c) a second harmonic generator for halving the wavelength of the modulated, infrared beam to generate a green laser beam having a wavelength on the order of 530 nanometers.

15. The electro-absorption modulated green laser system of claim 14, wherein the edge-emitting laser diode and the electro-absorption modulator are integrated on a common semiconductor chip.

16. The electro-absorption modulated green laser system of claim 14, wherein the second harmonic generator includes apoled waveguide for converting the wavelength of the infrared beam to the wavelength of the green laser beam.

17. The electro-absorption modulated green laser system of claim 14, and a thermoelectric cooler for controlling a temperature of the edge-emitting laser diode.
